(19) United States
(12) Patent Application Publication
(10) Pub. No.: US 2026/0109580 A1
(43) Pub. Date: Apr. 23, 2026

(54) HEEL FOR GRAPPLE ASSEMBLY

(71) Applicant: Komatsu America Corp., Chicago, IL (US)

(72) Inventor: Jessica Noelle HOLCOMB, Hixson, TN (US)

(21) Appl. No.: 19/365,698

(22) Filed: Oct. 22, 2025

Related U.S. Application Data
(60) Provisional application No. 63/710,873, filed on Oct. 23, 2024.

(51) Int. Cl. B66C 23/64; A01G 23/00; B66C 1/44

(52) U.S. Cl. CPC B66C 23/64; A01G 23/003; B66C 1/447

(57) ABSTRACT

A heel includes a grapple attachment portion, an arm attachment portion non movably connected to the grapple attachment portion, a rack attachment portion non movably connected to the arm attachment portion such that the arm attachment portion is disposed between the grapple attachment portion and the rack attachment portion, and at least one rack removably attached to the rack attachment portion. A work machine includes the heel, a main body, a boom pivotably connected to the main body, and an arm pivotably connected to the boom. The heel is connected to a free end of the arm.

### CROSS REFERENCE TO RELATED APPLICATIONS

This application claims the benefit under 35 U.S. C. § 119(e) of U.S. Provisional Application No. 63/710,873, filed Oct. 23, 2024. The entire disclosure of U.S. Provisional Application No. 63/710,873 is hereby incorporated herein by reference.

### BACKGROUND

### Field of the Invention

The present disclosure generally relates a heel, a grapple heel, a grapple assembly, fixed heel, live heel, and/or heel extension (hereafter simply referred to “heel”) for a work machine. More specifically, the present disclosure relates to a heel for a work machine, which typically comprises a combination rack and heel extension, and facilitates repair and/or modification of the heel rack(s).

### Background Information

Work vehicles are used in construction, farming, forestry, etc. Whether used in construction, farming, forestry, etc., work vehicles typically have one or more work implements or tools attached thereto to perform some work. On such a work vehicle, at least one work implement is coupled to the vehicle body and/or chassis. Regardless of the work implement, a work vehicle includes a ground propulsion apparatus that uses tracks or wheels to propel and/or steer the work vehicle. The tracks or wheels also serve to support the main body of the work vehicle. One example of a work vehicle is a forestry work vehicle that is used for logging (e.g., cutting trees and/or transporting felled trees) or various other forestry purposes. One example of a forestry work vehicle is a log loader. Another example of the forestry work vehicle is a forwarder. On a log loader, the work implement typically includes a grapple used to pick up and load felled trees onto a loading area. The loading area can be on the back of the forestry work vehicle or another location such as another vehicle or transport/loading area.

In the case of a log loader, the grapple is pivotally mounted at the end of a heel. The heel is pivotally mounted to an arm. The arm is pivotally mounted to a boom. The boom is pivotally mounted to the vehicle body or chassis. A hydraulic circuit is connected to a boom cylinder, a arm cylinder, a heel cylinder and grapple cylinder(s) to control movement of the grapple. An operator controls the movement and operation of the grapple by controlling the hydraulics using multiple operating members such as joysticks as well as other controls such as foot pedals and dash buttons/switches.

Some examples of work vehicles are disclosed in U.S. Pat. Nos. 6,551,051 B2, 5,320,149 A, 4,486,136 A, 3,709,390 A, 3,630,399 A, 11,884,523 B2.

### SUMMARY

A work machine often includes a ground propulsion apparatus such that the work machine is a work vehicle. The heel attachment on a forestry machine that utilizes a grapple is primarily utilized to control the log as it is being picked up and moved from one location to another. grapple, and a rear rack at the back of the heel that is further away from the grapple.

There are typically 2 primary log engagement pieces on a heel assembly. A mid and rear rack. However a design can incorporate additional racks.

It has been discovered that a heel is typically built as a structure of welded steel plate. If one of the racks becomes damaged, the rack could require fabrication methods to repair. This can be costly, time consuming, and relatively complicated.

Therefore, one object of this invention is a heel with bolt on racks that would make replacing the racks more cost effective from a material and labor standpoint.

It has also been discovered that depending on the grapple, different sized racks may be desired to better control the log size being grabbed.

Therefore, another object of this invention is to make it possible for an operator or a user to swap between different rack configurations.

It has also been discovered that depending on the grapple, different sized racks may be desired in order to facilitate transportation when the heel is folded under the arm.

Therefore, another object of this invention is to make it possible for an operator or a user to swap between different lengths of racks to allow for different positions of the grapple when folded for transportation.

It has also been discovered that it may be desirable to lengthen the heel for optimal rack positioning resulting in better control of some logs.

Therefore, another object of this invention is to make it possible for the heel to be lengthened with a bolt on extension that has a third rack on it if desired.

It has still also been discovered that it may be desirable to be able to change the tooth and/or surface profile where the logs engage on the rack(s) depending on the species of timber that is being harvested.

Therefore, another object of this invention is to make it possible for the rack(s) to be changed as needed for optimal handling of all species of timber.

A heel with bolt on racks would make replacing the racks more cost effective from a material and labor standpoint. Additionally, an operator or a user could swap between different configurations of racks to allow for different positions of the log as it is being moved.

In view of the state of the known technology and in accordance with a first aspect of the present disclosure, a heel is provided. The heel includes a grapple attachment portion, an arm attachment portion non movably connected to the grapple attachment portion, a rack attachment portion non movably connected to the arm attachment portion such that the arm attachment portion is disposed between the grapple attachment portion and the rack attachment portion, and at least one rack plate removably attached to the rack attachment portion. However, the design can incorporate additional removable attached rack attachment portions.

In accordance with second to eleventh aspects of the present disclosure, the heel of the first aspect may further include the feature(s) of any one or more of those recited in the second to eleventh claims filed herewith.

In accordance with twelfth and thirteenth aspects of the present disclosure, a grapple assembly includes a grapple and the heel of one or more of the first to eleventh aspects, and may further include the feature(s) of any one or more of those recited in the twelfth and thirteenth claims filed herewith.

In accordance with a fourteenth aspect of the present disclosure, a work machine can be provided that includes the grapple assembly of the twelfth and thirteenth aspects. The work machine further includes a main body, a boom pivotably connected to the main body, and an arm pivotably connected to the boom. The heel is connected to a free end of the arm. The grapple is pivotably connected to the end of the heel.

In view of the state of the known technology and in accordance with an fifteenth aspect of the present disclosure, a heel is provided. The heel includes a grapple attachment portion, an arm attachment portion non movably connected to the grapple attachment portion, a rack attachment portion non movably connected to the arm attachment portion such that the arm attachment portion is disposed between the grapple attachment portion and the rack attachment portion, and a heel extension portion. The rack attachment portion includes a first rack attachment section at a free end thereof. The heel extension portion is removably attached to the first rack attachment section. The heel extension portion includes at least one rack plate.

In accordance with sixteenth to twenty first aspects of the present disclosure, the heel of the fifteenth aspect may further include the feature(s) of any one or more of those recited in the sixteenth to twenty first claims filed herewith.

In accordance with twenty second and twenty third aspects of the present disclosure, a grapple assembly includes a grapple and the heel of one or more of the fifteenth to twenty first aspects, and may further include the feature(s) of any one or more of those recited in the twenty second and twenty third claims filed herewith.

In accordance with a twenty fourth aspect of the present disclosure, a work machine can be provided that that includes the grapple assembly of the twenty second or twenty third aspects. The work machine further includes a main body, a boom pivotably connected to the main body, and an arm pivotably connected to the boom. The heel is connected to a free end of the arm. The grapple is pivotably connected to the end of the heel.

It will be apparent to those having ordinary skill in the art from this disclosure that the above aspect are merely examples of illustrative embodiment(s) of this invention and do not limit the scope of this invention.

Also, other objects, features, aspects and advantages of the disclosed work vehicle will become apparent to those skilled in the work vehicle field from the following detailed description, which, taken in conjunction with the annexed drawings, discloses exemplary embodiments of the work vehicle.

### BRIEF DESCRIPTION OF THE DRAWINGS

Referring now to the attached drawings which form a part of this original disclosure:

FIG. 1 is a front-left side perspective view of a work machine, e.g. a work vehicle such as a log loader, including a tool having a heel in accordance with an embodiment;

FIG. 2 is an enlarged left side perspective view of the tool having the heel illustrated in FIG. 1;

FIG. 3 is a further enlarged perspective view of the heel illustrated in FIGS. 1-2, with the heel removed from the work machine and the grapple and racks removed from the heel;

FIG. 4 is a view of the heel illustrated in FIG. 3, but with a front (second or first) rack bolted thereto;

FIG. 5 is a view of the heel illustrated in FIG. 3, but with a front (second or first) rack and a rear (first or second) rack bolted thereto;

FIG. 6 is a view of the heel illustrated in FIG. 3, but with a front (second or first) rack and a modified reinforced wider rear (first or second) rack bolted thereto;

FIG. 7 is a front perspective view of the modified reinforced wider rear (first or second) rack illustrated in FIG. 6;

FIG. 8 is a rear perspective view of the modified reinforced wider rear (first or second) rack illustrated in FIGS. 6-7;

FIG. 9 is a view of the heel illustrated in FIG. 3, but with a front (second or first) rack and a heel extension portion bolted thereto, the heel extension portion having a rear (first or second) rack and an additional rack plate connected to the rear (first or second) rack by an extension section;

FIGS. 10-12 illustrate the heel and heel extension portion illustrated in FIG. 9, but with optional longitudinal teeth plates removed;

FIGS. 13-15 are views like FIGS. 10-12, respectively, but with a modified elongated heel extension portion, a modified additional rack plate at a different inclination angle, and with the optional longitudinal teeth plates shown in FIG. 9 removed;

FIG. 16A includes views of examples of grapples that can be used in accordance with this disclosure;

FIG. 16B includes views of an example of grapple linkages that can be used in accordance with this disclosure;

FIGS. 17-20 illustrate examples of other grapples commercially available and widely used; and

FIG. 21 is a perspective view illustrating a grapple being folded under a heel for the purpose of illustration.

### DETAILED DESCRIPTION OF THE EMBODIMENT(S)

Selected embodiments will now be explained with reference to the drawings. It will be apparent to those skilled in the art from this disclosure that the following description of the embodiments is provided for illustration only and not for the purpose of limiting the invention as defined by the appended claims and their equivalents.

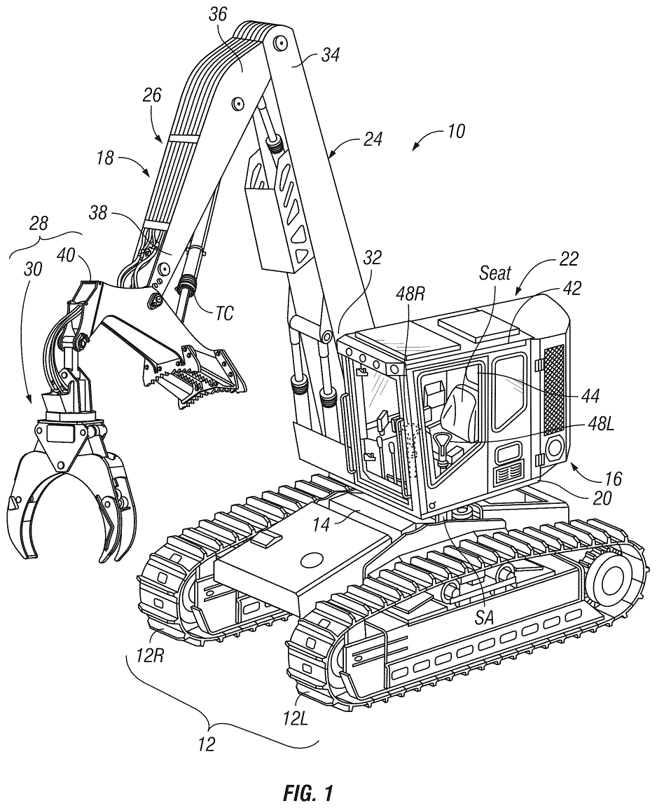

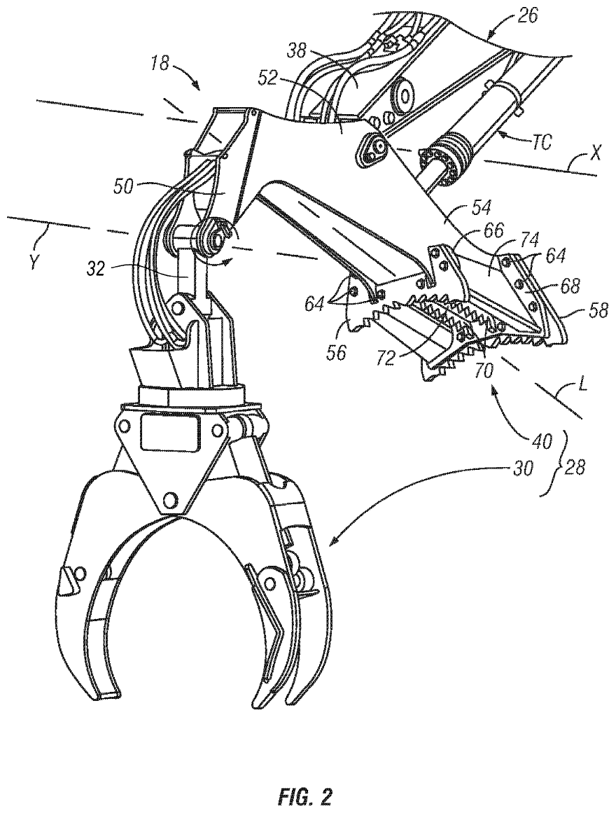

Referring initially to FIGS. 1-2, a work machine 10 is illustrated in accordance with this disclosure. In this disclosure, the work machine 10 is a work vehicle, which can be used to travel and perform work. As explained below, the work machine 10 has an improved work implement 18 mounted thereto. Specifically, the work implement 18 includes an improved heel 40, which will be explained in more detail below. In the illustrated embodiment(s), the work machine 10 is a log loader, such as a short tail tracked log loader.

In the illustrated embodiments, the work machine 10 includes a ground propulsion apparatus 12, a chassis 14, a vehicle body 16, and the work implement 18. In the illustrated embodiments, the ground propulsion apparatus 12 has a pair of tracks 12L and 12R used to propel and maneuver the work machine 10 in a conventional manner. However, it will be apparent to those skilled in the work vehicle field from this disclosure that the present disclosure is also applicable to wheeled work vehicles in which the tracks are replaced by wheels or some other means of moving the work machine 10 along the ground. Moreover, it will be apparent to those skilled in the work vehicle field from this disclosure that the present disclosure is also applicable stationary work machines. The ground propulsion apparatus 12 supports the chassis 14, which supports the vehicle body 16. The vehicle body 16 is pivotally supported by and attached to the ground propulsion apparatus 12 via the chassis 14. The work implement 18 is movably attached to the vehicle body 16. The vehicle body 16 includes a deck 20 on which an operator cab 22 is disposed and from which an operator can operate the work machine 10.

The ground propulsion apparatus 12 of the illustrated embodiments includes an undercarriage and other conventional parts that enable the work machine 10 to move along a ground surface. In the illustrated embodiments, the ground propulsion apparatus 12 includes the left or first track 12L and the right or second track 12R. The first and second tracks 12L and 12R are arranged to contact the ground surface. The first and second tracks 12L and 12R are driven by, for example, a hydraulic motor/pump (not shown) in a conventional manner. In the illustrated embodiment(s), the work machine 10 is a short tail tracked log loader in that the rear end of the vehicle body 16 does not extend beyond the first and second tracks 12L and 12R. In other words, a rearmost portion of the vehicle body 16 is positioned forward with respect to a rearmost end of the first and second tracks 12L and 12R when the vehicle body 16 is oriented facing forward without a swing angle. However, this disclosure could also be applicable to long tailed machines or other types of machines.

As shown in FIG. 1, the chassis 14 is basically a frame to which the ground propulsion apparatus 12 is attached. The chassis 14 is supported with respect to the ground surface by the ground propulsion apparatus 12 and serves to support the vehicle body 16 with respect to the ground propulsion apparatus 12. More specifically, the chassis 14 is configured to support a swing apparatus SA that supports the vehicle body 16 (e.g., the deck 20). The swing apparatus SA includes a swing bearing and a swing motor (not shown). In the illustrated embodiments, the swing motor, the swing bearing, and the vehicle body 16 are coupled together such that the vehicle body 16 can be rotated about a vertical swing axis by the swing motor. The vehicle body 16 is supported on the swing apparatus SA such that the vehicle body 16 is swingably mounted to the chassis 14 about the vertical swing axis. Although the illustrated embodiments are provided with the swing apparatus SA, the disclosure is not limited to a work machine that includes a swing apparatus. The vehicle body 16 can be non-rotatable or fixed with respect to the chassis 14. The swing apparatus SA can be leveling or non-leveling.

Referring still to FIGS. 1-2, in the illustrated embodiments, the work implement 18 includes a boom 24, an arm 26 and an attachment or work tool 28. In the illustrated embodiment(s), the work tool 28 includes a grapple 30 and the heel 40. Thus, the work tool 28 in this embodiment is a grapple assembly. The boom 24 has a vehicle attachment end 32 and an arm attachment end 34. The vehicle attachment end 32 is movably attached to at least one of the chassis 14 and the vehicle body 16. The arm attachment end 34 is attached to the arm 26. The arm 26 has a boom attachment end 36 and a tool attachment end 38. The boom attachment end 36 is pivotally coupled to the arm attachment end 34. The work tool 28 is coupled to the tool attachment end 38 of the arm 26. A pivotal connection attaches the boom 24 to the arm 26 in a conventional manner, such that the work machine 10 can be operated with the boom 24 and the arm 26 in a plurality of orientations. The boom 24 and the arm 26 are operated (moved) using a conventional hydraulic circuit in a conventional manner.

The vehicle body 16 includes the cab 22 as well as numerous other conventional components such as an engine compartment containing an engine, a main hydraulic housing containing the main vehicle hydraulics, and a counterweight supported on the deck 20. The deck 20 is a strong rigid plate shaped member constructed of for example steel plate material. The deck 20 can be constructed of multiple parts. The deck 20 is attached to the swing apparatus SA. In addition, the work implement 18 is movable attached to the deck 20 adjacent the cab 22.

The operator cab 22 includes a box shaped structure 42, a door 44, an operator's seat 46, a left control lever or joystick 48L, a right control lever or joystick 48R and a dashboard including various operating members useable by the operator to operate the work machine 10. In the illustrated embodiments, left and right control joysticks 48L and 48R are illustrated. However, these are merely two examples of possible control levers. The box shaped structure 42 is constructed of rigid plate material and can be constructed of several parts attached to each other. The box shaped structure 42 has various cutouts with windows mounted therein, and a door opening with the door 44 pivotally mounted therein in a conventional manner. The door 44 is openable and closable to allow an operator to enter and exit the cab 22 in a conventional manner.

In the illustrated embodiments, numerous operating members (user inputs) are provided to be operated by hand, and pedal type operating members (not shown) are provided on the floor to be operated by foot. There are no particular limitations on the arrangement and type of operating members provided in the operator cab 22. The foot pedals can be used to control the ground propulsion apparatus 12 to control movement of the overall position of the work machine 10 itself over the terrain. The operating members on the dashboard are preferably arranged in positions where they are easy for the operator to access and do not obstruct the operator's field of view. In the illustrated embodiments, as one example, the dashboard is positioned to the right of the operator. Operating members on the dashboard can be physical buttons, switches, etc. In addition or alternatively, it will be apparent to those of ordinary skill in the art that one or more touch screens can be used instead of the physical buttons, switches, etc. or in addition to (i.e., to provide redundant control) the physical buttons, switches, knobs, etc.

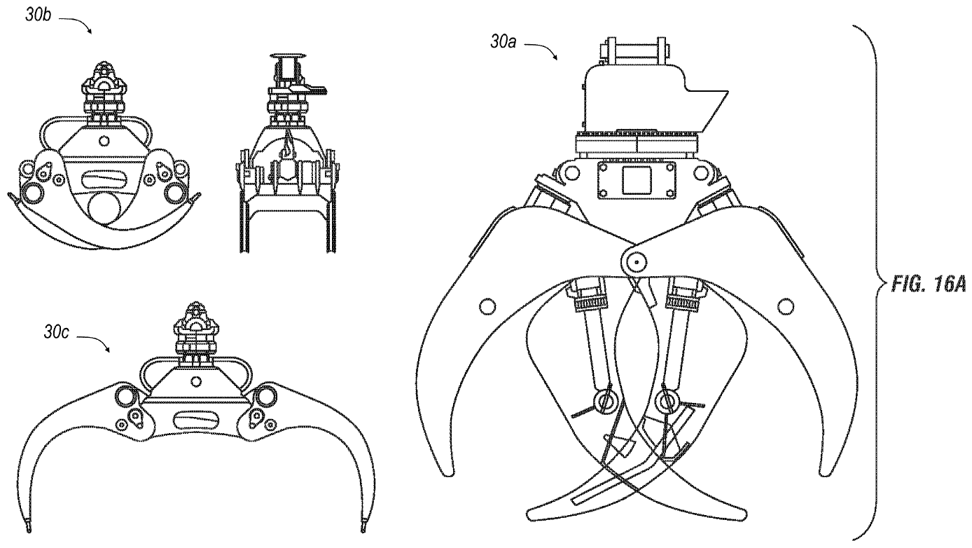

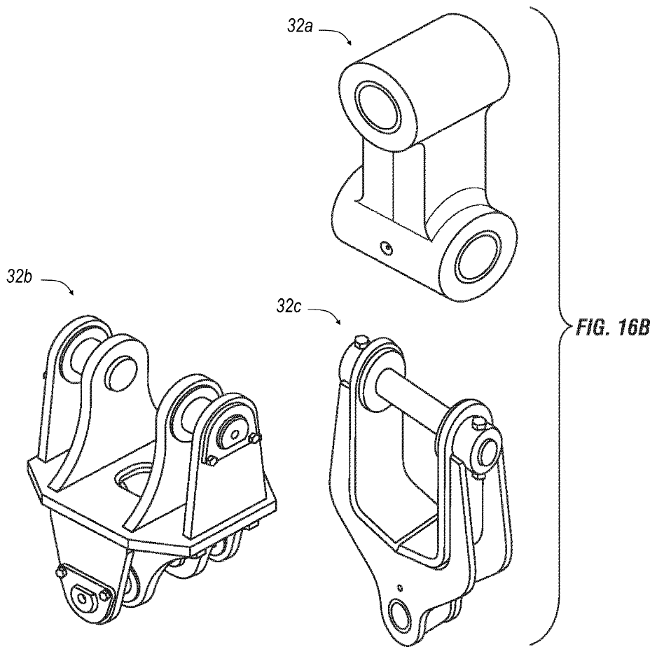

Referring now to FIGS. 2-5, the tool (grapple assembly) 28 including the grapple 30 and the grapple heel 40 will now be discussed in more detail. The grapple 30 is preferable conventional, and thus, will not be explained and/or illustrated in detail herein except as needed to understand the embodiment(s). In fact, FIGS. 16A and 16B—illustrate other examples of grapples 30a, 30b, 30c, different from the grapple shown in FIGS. 1-2, which could be usable with the embodiment(s). When the grapple 30 is attached to the heel 40, the grapple 30 can be considered part of the grapple assembly (tool) 28. In either case, the grapple 30 and the heel 40 are parts of the tool 28, which in this case is usable to grasp and move felled trees.

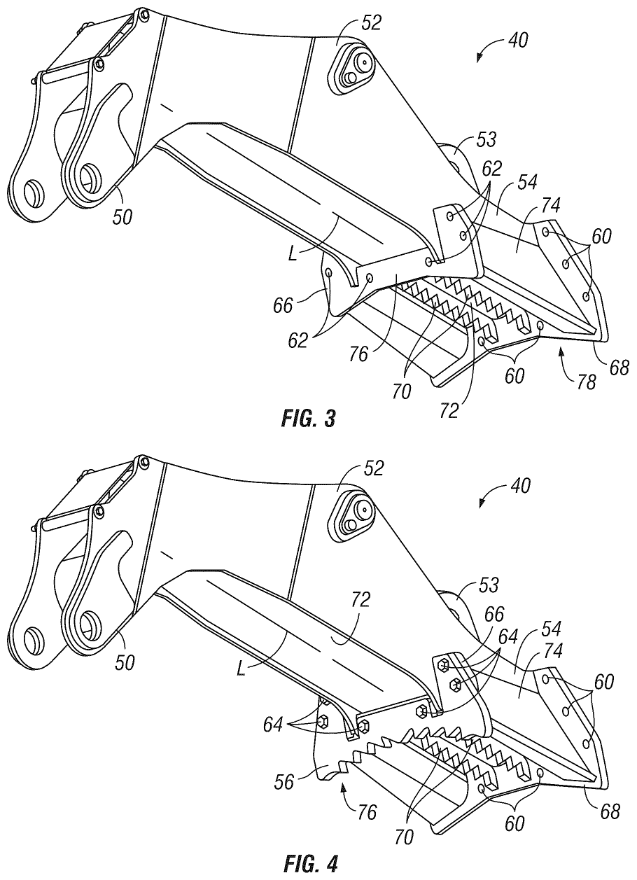

The heel 40 includes a grapple attachment portion 50, an arm attachment portion 52 non movably connected to the grapple attachment portion 50, a rack attachment portion 54 non movably connected to the arm attachment portion 52 such that the arm attachment portion 52 is disposed between the grapple attachment portion 50 and the rack attachment portion 54, a front (first or second) rack 56, and a rear (second or first) rack 58. The racks 56 and 58 are removably attached to the rack attachment portion 54. While a pair (a plurality) of rack plates 56 and 58 are illustrated, at least one rack plate 56 or 58 is removably attached to the rack attachment portion 54. The grapple attachment portion 50, the arm attachment portion 52, and the rack attachment portion 54 are rigidly, non movable attached to each other. For example, in the illustrated embodiment, the grapple attachment portion 50, the arm attachment portion 52, and the rack attachment portion 54 are preferable constructed using one or a plurality of steel plates that are welded together to form the general configuration shown in FIG. 3. In addition, as illustrated in FIG. 2, a grapple linkage 32 is used to pivotally attach the grapple 30 to the grapple attachment portion 50.

Referring still to FIGS. 2-5, the rack attachment portion 54 in the illustrated embodiment includes rear (first or second) mounting holes 60, front (second or first) mounting holes 62, a plurality of fasteners 64, a rear (first or second) rack attachment section 68 disposed at a free end of the rack attachment portion 54 and a front (second or first) rack attachment section 66 spaced toward the arm attachment portion 52 from the rear rack attachment section 68. The rear (first or second) rack 58 is removably attached to the rear (first or second) rack attachment section 68 using the rear (first or second) mounting holes 60 and fasteners 64. The front (second or first) rack 56 is removably attached to the front (second or first) rack attachment section 66 using the front (second or first) mounting holes 62 and the fasteners 64.

The rear (first or second) rack attachment section 68 includes a rear (first or second) planar element 78 with at least one rear (first or second) mounting hole 60 that receives at least one first removable fastener 64 to attach the rear (first or second) rack 58 to the rear (first or second) rack attachment section 68. The rack attachment sections are each preferably constructed of rigid plate material such as metal (e.g., steel) that are welded to the rear portion of the heel 40. The front (second or first) rack attachment section 66 includes a front planar element 76 with at least one front (second or first) mounting hole 62 that receives at least one second removable fastener 64 to attach the front (second or first) rack 56 to the front (second or first) rack attachment section 66.

In addition, a pair of reinforcing toothed ribs 70 are welded or otherwise fixedly attached to the front (first or second) rack attachment section 66, the rear (second or first) rack attachment section 68 and/or a planar surface 72 extending therebetween, as best seen in FIGS. 3-5. Moreover, side reinforcing plates 74 (only one shown) may also be included, which are welded or otherwise fixedly attached to the front (first or second) rack attachment section 66, the rear (second or first) rack attachment section 68 and/or side planar surfaces of the heel 40, as best seen in FIGS. 3-5. The heel 40 preferably has a symmetrical configuration such that the opposite side (not shown) has the same configuration as the side shown. Preferably the reinforcing ribs 70 and the side plates 74 are welded or otherwise fixedly attached to the front (first or second) rack attachment section 66 and the rear (second or first) rack attachment section 68. This piece is then welded or otherwise fixedly attached to the outer surfaces of the rack attachment portion 54 of the heel 40, as best seen in FIGS. 3-5.

Referring still to FIGS. 2-5, in the illustrated embodiment, the at least one first mounting hole 60 includes a plurality of first mounting holes 60 and the at least one first removable fastener 64 includes a plurality of first removable fasteners 64, and the at least one second mounting hole 62 includes a plurality of second mounting holes 62 and the at least one second removable fastener 64 includes a plurality of second removable fasteners 64. Moreover, in the illustrated embodiment, the first and second removable fasteners 64 are bolts. Due to this arrangement, the racks 56 and 58 can be removably attached to the rack attachment portion 54 using the bolts 64. Thus, if one of the plates 56 or 58 is damaged, e.g. due to contact with the ground or simply due to extended use, the damaged rack 56 and/or 58 can be replaced. In addition, it may be desired to replace one both of the racks 56 and 58 due to use compatibility with a particular grapple or log size, namely a length and/or thickness (diameter) of the log. Moreover, it may be desired to replace one both of the racks 56 and 58 due to travel compatibility with a particular grapple 30 when the grapple 30 is folded such as is shown in FIG. 21. Because of the bolt on configuration, racks can be removed and replaced without replacement of the entire heel 40.

Referring again to FIGS. 1-5, the arm attachment portion 52 is configured to be pivotally attached to the arm 26 in order to be swingable about to a heel swing axis X transverse relative to a longitudinal axis L of the heel 40. In addition, the heel may also include a tool cylinder attachment portion 53 configured to be connected to a tool cylinder TC to cause the heel 40 to swing about the heel swing axis X in response to extension and retraction of the tool cylinder TC. When the grapple 30 is attached to the heel 40, the grapple 30 is pivotally attached to the grapple attachment portion 50 in order to be swingable about to a grapple swing axis Y transverse relative to the longitudinal axis L of the heel 40. In the illustrated embodiment, the axis X is parallel to the axis Y. MODIFIED EXAMPLE 1 (Reinforced Wider Rear Racks)

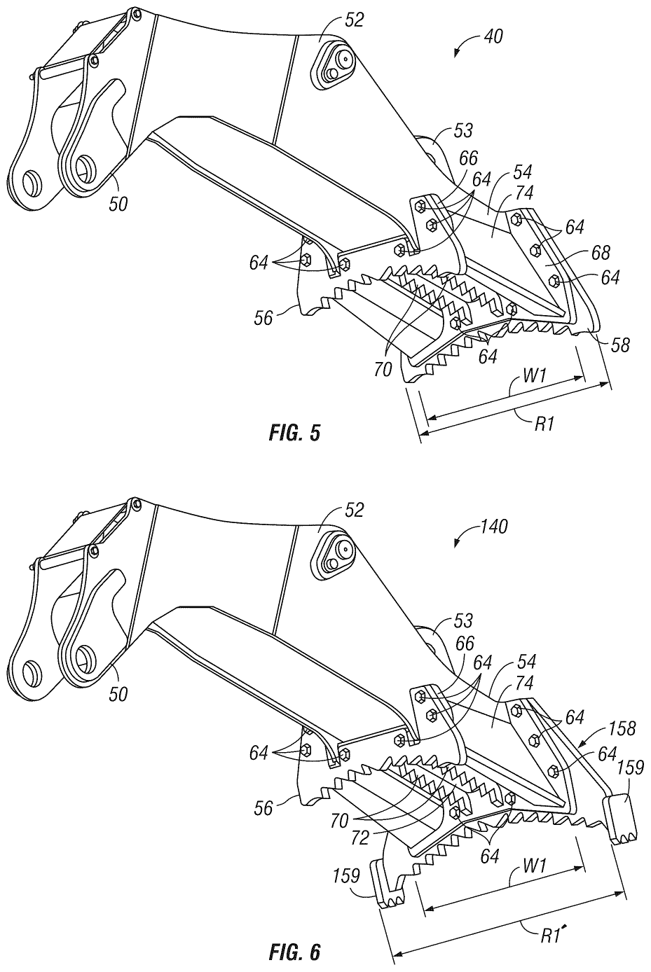

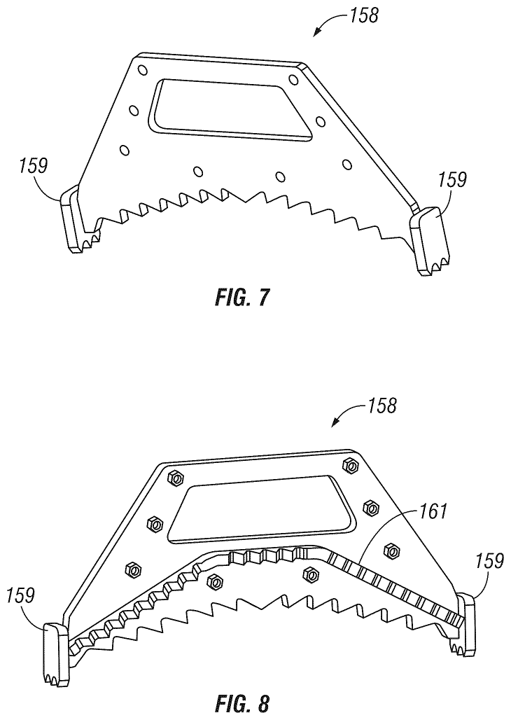

In the embodiment shown in FIGS. 1-5, the first rack attachment section has a first attachment width W1, and the first rack 58 has a first rack width R1 that is about 1.0 to 2.0 times the first attachment width W1. See FIG. 5. However, in a modified example illustrated in FIGS. 6-8, a heel 140 with a modified first rack 158. Otherwise, the heel 140 is identical to the heel 40, except for the rear rack 158. The first rack 158 has a first rack width R1′ that is about 1.10 to 2.2 times the first attachment width W1. See FIG. 6. In addition, the modified first rack 158 has reinforcement plates 159 non-movably attached to lateral edges thereof in an orthogonal arrangement relative to the first rack 158. Moreover, as best seen in FIG. 8, the modified first rack 158 includes a toothed reinforcing rib 161 welded or otherwise fixedly attached to a back surface thereof (not shown in 6-7). The modified rear rack 158 is an example of an alternative to rack 58 shown in FIGS. 1-5, to be used in place of the rack 58 if a wider design is desired.

### Modified Example 2 (Heel Extension)

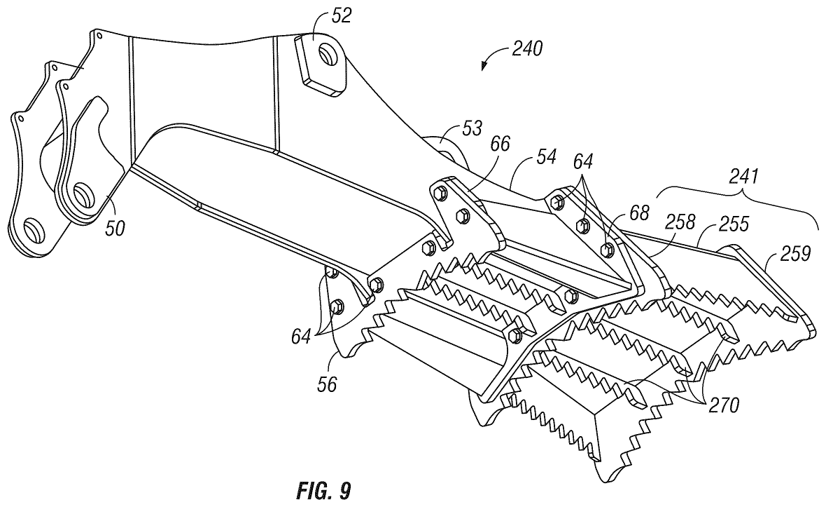

Referring now to FIG. 9, a heel 240 with a heel extension 241 in accordance with a modified example 2 will now be discussed. The heel 240 is identical to the heel 40, except the rear rack 58 is replaced with the heel extension 241. The heel extension 241 is removably attached to the first rack attachment section 68. The heel extension 241 includes a first rack 258 removably attached to the first rack attachment section 68, an extension section 255 non-movably connected to the first rack 258 and extending away from the first rack 258, and an additional rack 259 non-movably connected to a free end of the extension section 255 so as to be spaced from the first rack 258. The racks 258 and 259 are constructed of rigid plate material such as steel. Similarly, the extension section 255 is also constructed if rigid plate material such as steel. However the extension section 255 preferable has an inverted U-shaped or a concave configuration. The extension section 255 can be constructed of a single plate bent into the desired shape or multiple plates welded to form the illustrated shape.

The first rack 258 is identical to the rear rack 58. Likewise, the heel 40 previously illustrated and discussed is used with the heel extension 241 to form the modified heel 240. The first rack 258, the extension section 255, and the additional rack 259 are welded or otherwise non-movably fixed to each other. The first rack 258 is used to attach the heel extension 241 to the rear (first) rack attachment section 68 in a manner identical to the rear racks 58 and 158 explained above using the fasteners 64. Optionally, one or more (three shown) toothed reinforcing ribs 270 may be welded or otherwise non-movably fixed to the first rack 258, the extension section 255, and/or the additional rack 259.

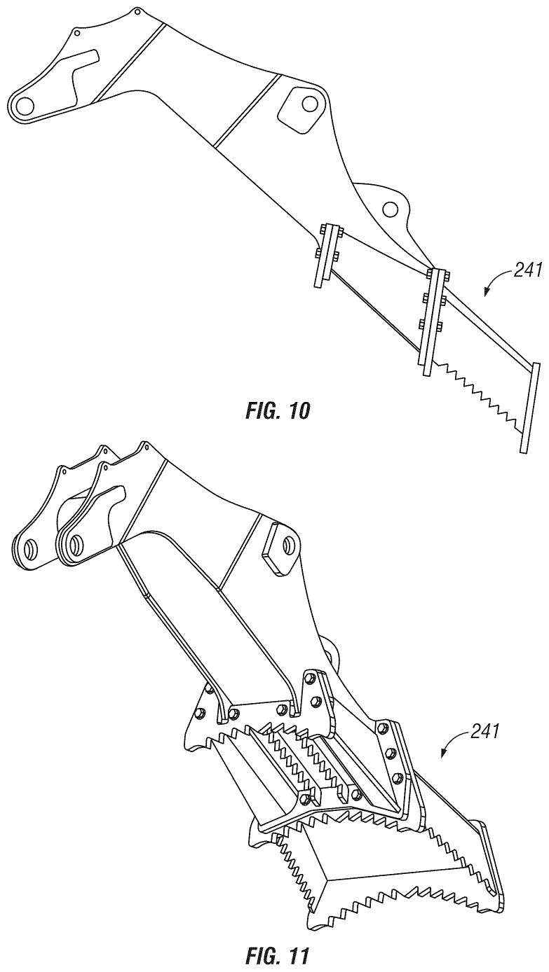

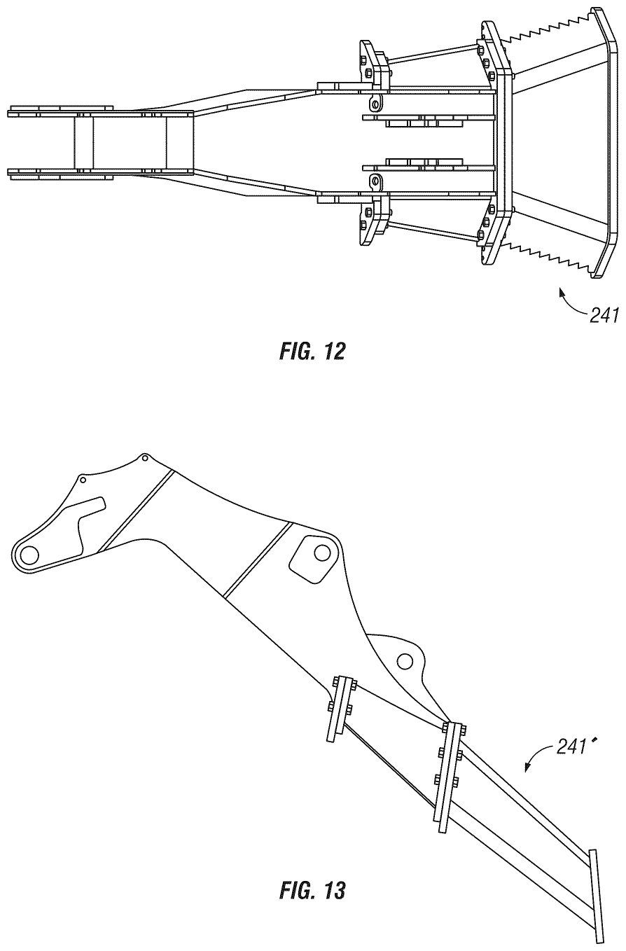

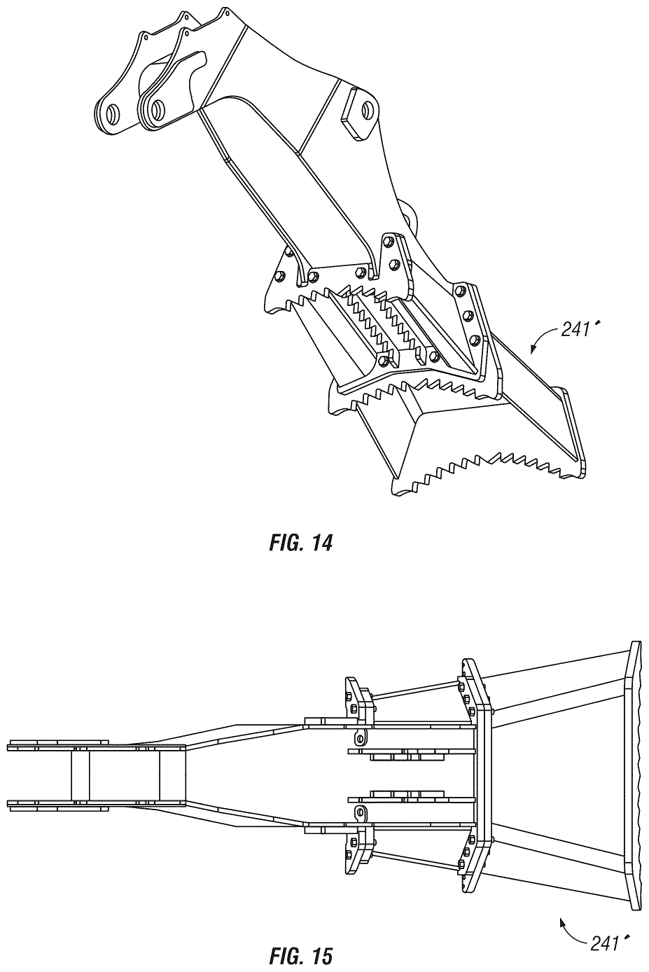

Referring to FIGS. 10-12 and FIGS. 13-15, two examples of the heel extension 241 and 241′ are shown. In these examples, the toothed reinforcing ribs 270 are removed. However, one or more reinforcing ribs 270 may be used. Otherwise, the example 241 in FIGS. 10-12 corresponds to FIG. 9. On the other hand, the example 241′ of FIGS. 13-15 illustrates two additional modifications, (1) increased length of the heel extension, and (2) a different angle for the additional rack 259. One or both of these additional modifications may be adopted in Modified Example 2, if needed and/or desired.

### Additional Features Different Grapples

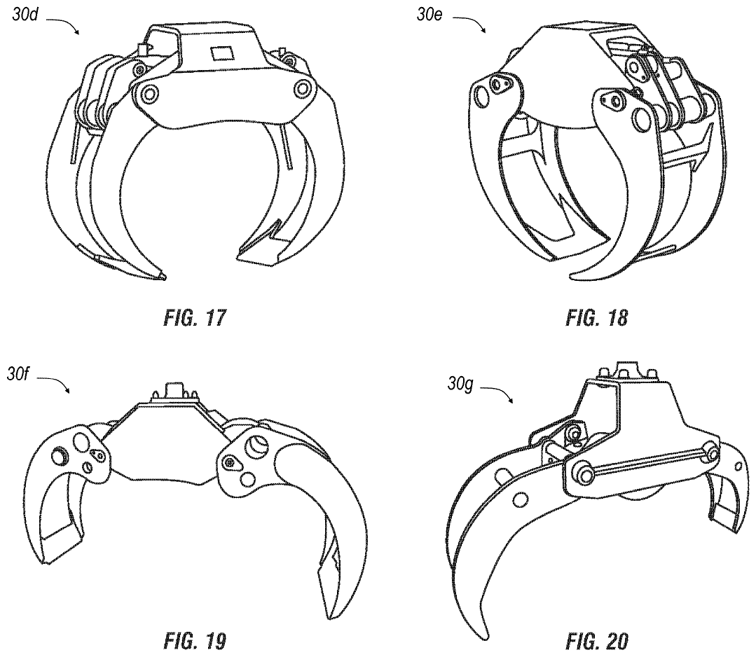

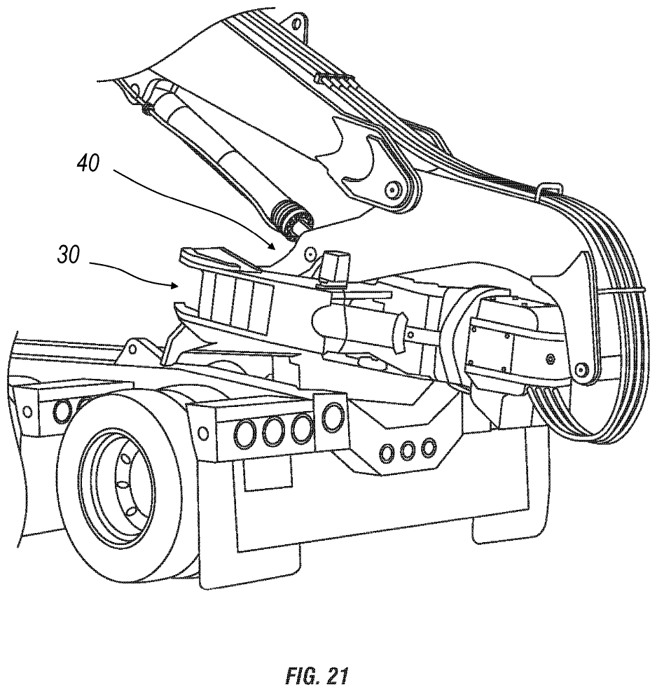

Various types of the grapples and the grapple linkages that suit the grapples are sold. Some additional examples, namely grapples 30a-30g and grapple linkages 32a-32c are illustrated in FIGS. 16A, 16B, and 17-20. The user may select their grapple that fits their work (size, length of the log etc.). The grapple is attached to the machine during the transportation (a work base to a forest, a forest to another forest). Therefore, it is convenient if the heel 40 has a support for the grapple 30 due to the transportation arrangement shown in FIG. 21. However, the size of the support portion on the heel has to be adjusted to the user's specific grapple size. If the support portion is welded integrally to the heel, it cannot be adjusted to the grapple. This disclosure enables changing the heel (width length, etc) to receive user's grapple actually used, since the heel is not welded but is bolt on.

Many parts of the work vehicle are conventional components that are well known in the work vehicle field. Since these components are well known in the work vehicle field, these structures will not be discussed or illustrated in detail herein, except as related to the disclosure set forth in the following claims.

As used herein, the following directional terms “forward, rearward, above, downward, vertical, horizontal, below and transverse” as well as any other similar directional terms refer to those directions of a work vehicle on a level surface. Accordingly, these terms, as utilized to describe the present disclosure should be interpreted relative to a work vehicle equipped with the present disclosure. The terms of degree such as “substantially”, “about” and “approximately” as used herein mean a amount of deviation of the modified term such that the end result is not significantly changed.

While only selected embodiments have been chosen to illustrate the present invention, it will be apparent to those skilled in the work vehicle field from this disclosure that various changes and modifications can be made herein without departing from the scope of the invention as defined in the appended claims. Furthermore, the foregoing descriptions of the embodiments according to the present disclosure are provided for illustration only, and not for the purpose of limiting the invention as defined by the appended claims and their equivalents. Thus, the scope of the invention is not limited to the disclosed embodiments.

What is claimed is:

1. A heel comprising:
a grapple attachment portion;
an arm attachment portion non movably connected to the grapple attachment portion;
a rack attachment portion non movably connected to the arm attachment portion such that the arm attachment portion is disposed between the grapple attachment portion and the rack attachment portion; and
at least one rack removably attached to the rack attachment portion.

2. The heel according to claim 1, wherein
the at least one rack includes a plurality of racks attached to the rack attachment portion.

3. The heel according to claim 1, wherein
the rack attachment portion includes
a first rack attachment section disposed at a free end of the rack attachment portion and
a second rack attachment section spaced toward the arm attachment portion from the first rack attachment section,
the at least one rack includes
a first rack removably attached to the first rack attachment section, and
a second rack removably attached to the second rack attachment section.

4. The heel according to claim 3, wherein
the first rack attachment section includes a first planar element with at least one first mounting hole that receives at least one first removable fastener to attach the first rack to the first rack attachment section, and
the second rack attachment section includes a second planar element with at least one second mounting hole that receives at least one second removable fastener to attach the second rack to the second rack attachment section.

5. The heel according to claim 4, wherein
the first and second removable fasteners are bolts.

6. The heel according to claim 3, further comprising:
a heel extension portion removably attached to the first rack attachment section.

7. The heel according to claim 6, wherein
the heel extension portion includes
the first rack removably attached to the first rack attachment section,
an extension section non-movably connected to the first rack and extending away from the first rack, and
an additional rack non-movably connected to a free end of the extension section so as to be spaced from the first rack.

8. The heel according to claim 3, wherein
the first rack attachment section has a first attachment width, and the first rack has a width that is about 1.0 to 2.0 times the first attachment width.

9. The heel according to claim 3, wherein
the first rack has reinforcement plates non-movably attached to lateral edges thereof in an orthogonal arrangement relative to the first rack.

10. The heel according to claim 1, wherein
the arm attachment portion is configured to be pivotally attached to the arm to in order to be swingable about to a heel swing axis transverse relative to a longitudinal axis of the heel.

11. The heel according to claim 10, further comprising:
a tool cylinder attachment portion configured to be connected to a tool cylinder to cause the heel to swing about the heel swing axis in response to extension and retraction of the tool cylinder.

12. A grapple assembly including the heel according to claim 1, the grapple assembly further comprising:
a grapple attached to the grapple attachment portion.

13. The grapple assembly according to claim 12, wherein
the grapple is pivotally attached to the grapple attachment portion in order to be swingable about to a grapple swing axis transverse relative to a longitudinal axis of the heel.

14. A work machine including the grapple assembly according to claim 12, the work machine further comprising:
a main body;
a boom pivotably connected to the main body; and
an arm pivotably connected to the boom, the heal being connected to a free end of the arm.

15. A heel comprising:
a grapple attachment portion;
an arm attachment portion non movably connected to the grapple attachment portion;
a rack attachment portion non movably connected to the arm attachment portion such that the arm attachment portion is disposed between the grapple attachment portion and the rack attachment portion, the rack attachment portion including a first rack attachment section at a free end thereof; and
a heel extension portion removably attached to the first rack attachment section, the heel extension portion including at least one rack.

16. The heel according to claim 15, wherein
the heel extension portion includes
a first rack removably attached to the first rack attachment section,
an extension section non-movably connected to the first rack and extending away from the first rack, and
an additional rack non-movably connected to a free end of the extension section so as to be spaced from the first rack.

17. The heel according to claim 15, wherein
the rack attachment portion includes a second rack attachment section spaced from the first rack attachment section toward the grapple attachment portion, and a second rack is removably attached to the second rack attachment section.

18. The heel according to claim 16, wherein
the first rack attachment section includes a first planar element with at least one first mounting hole that receives at least one first removable fastener to attach the first rack to the first rack attachment section.

19. The heel according to claim 18, wherein
the at least one first removable fasteners is/are bolts.

20. The heel according to claim 15, wherein
the arm attachment portion is configured to be pivotally attached to the arm to in order to be swingable about to a heel swing axis transverse relative to a longitudinal axis of the heel.

21. The heel according to claim 20, further comprising:
a tool cylinder attachment portion configured to be connected to a tool cylinder to cause the heel to swing about the heel swing axis in response to extension and retraction of the tool cylinder.

22. A grapple assembly including the heel according to claim 15, the grapple assembly further comprising:
a grapple attached to the grapple attachment portion.

23. The grapple assembly according to claim 22, wherein
the grapple is pivotally attached to the grapple attachment portion in order to be swingable about to a grapple swing axis transverse relative to a longitudinal axis of the heel.

24. A work machine including the grapple assembly according to claim 22, the work machine further comprising:
a main body;
a boom pivotably connected to the main body; and
an arm pivotably connected to the boom, the heel being connected to a free end of the arm.
